(19) United States
(12) Patent Application Publication
(10) Pub. No.: US 2026/0035559 A1
(43) Pub. Date: Feb. 5, 2026

(54) RESIN COMPOSITION AND ARTICLE MADE THEREFROM

(71) Applicant: Elite Material Co., Ltd., Taoyuan City (TW)

(72) Inventor: Chen-Yu HSIEH, Taoyuan City (TW)

(21) Appl. No.: 18/814,265

(22) Filed: Aug. 23, 2024

(30) Foreign Application Priority Data
Jul. 31, 2024 (TW) 113128565

(51) Int. Cl. C08L 71/12; C08J 5/24; C08K 3/36; C08K 5/14; C08L 9/00; C08L 65/02

(52) U.S. Cl. CPC C08L 71/126; C08J 5/24; C08K 3/36; C08K 5/14; C08L 9/00; C08L 65/02; C08J 2309/00; C08J 2365/02; C08J 2371/12; C08J 2409/06; C08J 2485/02; C08L 2201/02; C08L 2203/16; C08L 2203/20

(57) ABSTRACT

A resin composition includes a vinyl group-containing resin and a phosphorus-containing copolymer, wherein the phosphorus-containing copolymer is prepared from a mixture subjected to a copolymerization reaction, and the mixture includes a vinyl group-containing benzocyclobutene of Formula (1) and a phosphorus-containing compound of Formula (2). The resin composition may be used to make various articles, including a resin film, a prepreg, a laminate or a printed circuit board, and one or more of the properties can be improved, including dissipation factor, copper foil peeling strength, flame resistance and X-axis coefficient of thermal expansion.

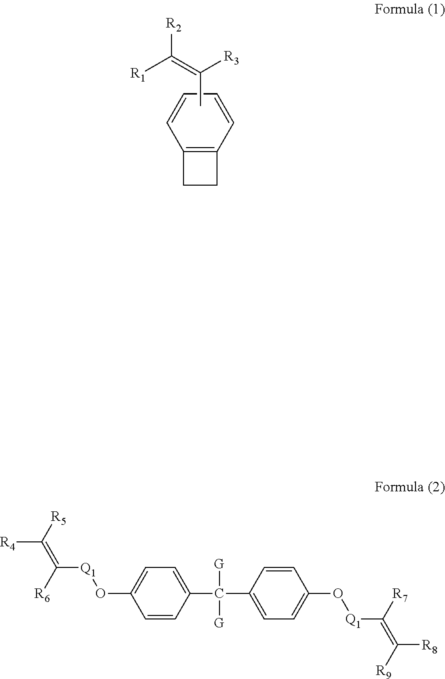

### CROSS-REFERENCE TO RELATED APPLICATION

This application claims the priority benefits of Taiwan Patent Application No. 113128565, filed on Jul. 31, 2024. The entirety of the above-mentioned patent application is hereby incorporated by reference herein and made a part of this specification.

### BACKGROUND

### 1. Field of the Disclosure

The present disclosure relates to a resin composition and more particularly to a resin composition useful for preparing a prepreg, a resin film, a laminate or a printed circuit board.

### 2. Description of Related Art

In recent years, due to the development of electronic signal transmission toward 5G and the trend of miniaturization and high performance of electronic equipment, communication devices and personal computers, circuit boards for these applications were also developed toward multi-layer configuration, high density trace interconnection, and high speed signal transmission, thereby presenting higher challenges to the overall performance of circuit laminates such as copper-clad laminates.

Accordingly, there is a need to provide a novel material meeting the property requirements of circuit boards used nowadays.

### SUMMARY

To overcome the problems of prior arts, particularly one or more property demands facing conventional materials, it is a primary object of the present disclosure to provide a resin composition and an article made from the resin composition, which may achieve improvements in at least one or more desirable properties including dissipation factor, copper foil peeling strength, flame resistance and X-axis coefficient of thermal expansion.

To achieve the above-mentioned object, the present disclosure provides a resin composition comprising a vinyl group-containing resin and a phosphorus-containing copolymer, wherein the phosphorus-containing copolymer is prepared from a mixture subjected to a copolymerization reaction, and the mixture comprises a vinyl group-containing benzocyclobutene of Formula (1) and a phosphorus-containing compound of Formula (2):

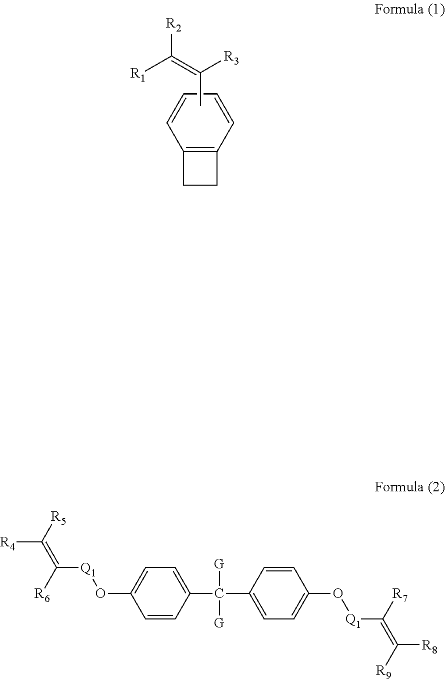

wherein R₁ to R₉ are each independently hydrogen or a C1 to C3 alkyl group, Q₁ are each independently a —(C═O)— group or a *—CH₂-C₆H₄— group, wherein * indicates bonding to oxygen atom, and each G is independently a monovalent phosphorus-containing group represented by Formula (3) or Formula (4);

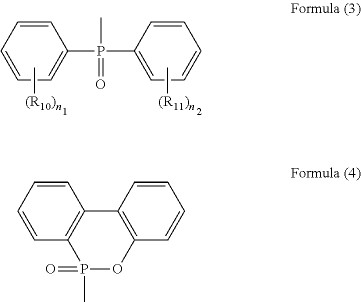

wherein n₁ and n₂ are each independently an integer of 0 to 3, and R₁₀ and R₁₁ are each independently a C₁ to C₃ alkyl group.

For example, in one embodiment, a molar ratio of the vinyl group-containing benzocyclobutene of Formula (1) and the phosphorus-containing compound of Formula (2) in the mixture is between 1:7 and 3:7.

For example, in one embodiment, the phosphorus-containing copolymer has a weight average molecular weight of between 3,000 and 5,000.

For example, in one embodiment, the resin composition comprises 100 parts by weight of the vinyl group-containing resin and 25 parts by weight to 50 parts by weight of the phosphorus-containing copolymer.

For example, in one embodiment, the vinyl group-containing resin comprises a vinyl group-containing polyphenylene ether resin, a maleimide resin, bis(vinylphenyl)ethane, a compound of Formula (5), a styrene-butadiene copolymer, a polybutadiene resin, a diene-containing fluorene compound, a divinylbenzene-terminated hydrogenated polybutadiene resin or a combination thereof,

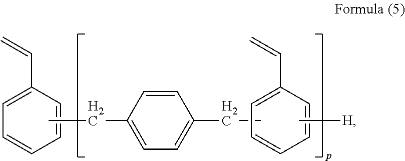

wherein p is 1 to 20.

For example, in one embodiment, the resin composition further comprises inorganic filler, curing accelerator, flame retardant, polymerization inhibitor, solvent, silane coupling agent, coloring agent, toughening agent or a combination thereof.

Moreover, the present disclosure also provides an article made from the resin composition described above, which comprises a prepreg, a resin film, a laminate or a printed circuit board.

For example, in one embodiment, articles made from the resin composition disclosed herein have one, more or all of the following properties:
a dissipation factor as measured by reference to JIS C2565 at 10 GHz of less than or equal to 0.0027;
a copper foil peeling strength as measured by reference to IPC-TM-650 2.4.8 of greater than or equal to 4.12 lb/in;
a flame retardancy of V-O rating as measured by reference to UL94 standard; and
an X-axis coefficient of thermal expansion as measured by reference to IPC-TM-650 2.4.24.5 of less than or equal to 11.7 ppm/° C.

### DESCRIPTION OF THE EMBODIMENTS

To enable those skilled in the art to further appreciate the features and effects of the present disclosure, words and terms contained in the specification and appended claims are described and defined. Unless otherwise defined, all technical and scientific terms used herein have the same meaning as commonly understood by those of ordinary skill in the art to which this disclosure pertains. In the case of conflict, the present document and definitions contained herein will control.

While some theories or mechanisms may be proposed herein, the present disclosure is not bound by any theories or mechanisms described regardless of whether they are right or wrong, as long as the embodiments can be implemented according to the present disclosure.

As used herein, “a,” “an” or any similar expression is employed to describe components and features of the present disclosure. This is done merely for convenience and to give a general sense of the scope of the present disclosure. Accordingly, this description should be read to include one or at least one and the singular also includes the plural unless it is obvious to mean otherwise.

As used herein, “or a combination thereof” means “or any combination thereof”, and “any” means “any one”, vice versa.

As used herein, the term “comprises,” “comprising,” “includes,” “including,” “encompass,” “encompassing,” “has,” “having” or any other variant thereof is construed as an open-ended transitional phrase intended to cover a non-exclusive inclusion. For example, a composition or article of manufacture that comprises a list of elements is not necessarily limited to only those elements but may include other elements not expressly listed but inherent to such composition or article of manufacture. Further, unless expressly stated to the contrary, the term “or” refers to an inclusive or and not to an exclusive or. For example, a condition “A or B” is satisfied by any one of the following: A is true (or present) and B is false (or not present), A is false (or not present) and B is true (or present), and both A and B are true (or present). In addition, whenever open-ended transitional phrases are used, such as “comprises,” “comprising,” “includes,” “including,” “encompass,” “encompassing,” “has,” “having” or any other variant thereof, it is understood that transitional phrases such as “consisting essentially of” and “consisting of” are also disclosed and included.

As used herein, the term “and” or any other variant thereof is used to connect parallel sentence components, and there is no distinction between the front and rear components. The meaning of the parallel sentence components does not change in the grammatical sense after the position is exchanged.

In this disclosure, features or conditions presented as a numerical range or a percentage range are merely for convenience and brevity. Therefore, a numerical range or a percentage range should be interpreted as encompassing and specifically disclosing all possible subranges and individual numerals or values therein, particularly all integers therein. For example, a range of “1 to 8” should be understood as explicitly disclosing all subranges such as 1 to 7, 2 to 8, 2 to 6, 3 to 6, 4 to 8, 3 to 8 and so on, particularly all subranges defined by integers, as well as disclosing all individual values such as 1, 2, 3, 4, 5, 6, 7 and 8. Similarly, a range of “between 1 and 8” should be understood as explicitly disclosing all ranges such as 1 to 8, 1 to 7, 2 to 8, 2 to 6, 3 to 6, 4 to 8, 3 to 8 and so on and encompassing the end points of the ranges. Unless otherwise defined, the aforesaid interpretation rule should be applied throughout the present disclosure regardless broadness of the scope.

Whenever amount, concentration or other numeral or parameter is expressed as a range, a preferred range or a series of upper and lower limits, it is understood that all ranges defined by any pair of the upper limit or preferred value and the lower limit or preferred value are specifically disclosed, regardless whether these ranges are explicitly described or not. In addition, unless otherwise defined, whenever a range is mentioned, the range should be interpreted as inclusive of the endpoints and every integers and fractions in the range.

Given the intended purposes and advantages of this disclosure are achieved, numerals or figures have the precision of their significant digits. For example, 40.0 should be understood as covering a range of 39.50 to 40.49.

As used herein, a Markush group or a list of items is used to describe examples or embodiments of the present disclosure. A skilled artisan will appreciate that all subgroups of members or items and individual members or items of the Markush group or list can also be used to describe the present disclosure. For example, when X is described as being “selected from a group consisting of X₁, X₂ and X₃,” it is intended to disclose the situations of X is X₁ and X is X₁ and/or X₂ and/or X₃. In addition, when a Markush group or a list of items is used to describe examples or embodiments of the present disclosure, a skilled artisan will understand that any subgroup or any combination of the members or items in the Markush group or list may also be used to describe the present disclosure. Therefore, for example, when X is described as being “selected from a group consisting of X₁, X₂ and X₃” and Y is described as being “selected from a group consisting of Y₁, Y₂ and Y₃,” the disclosure includes any combination of X is X₁ and/or X₂ and/or X₃ and Y is Y₁ and/or Y₂ and/or Y₃.

Unless otherwise specified, according to the present disclosure, a compound refers to a chemical substance formed by two or more elements bonded with chemical bonds and may comprise a small molecule compound and a polymer compound, but not limited thereto. Any compound disclosed herein is interpreted to not only include a single chemical substance but also include a class of chemical substances having the same kind of components or having the same property. In addition, as used herein, a mixture refers to a combination of two or more compounds.

Unless otherwise specified, according to the present disclosure, a polymer refers to the product formed by monomer(s) via polymerization and usually comprises multiple aggregates of polymers respectively formed by multiple repeated simple structure units by covalent bonds; the monomer refers to the compound forming the polymer. A polymer may comprise a homopolymer, a copolymer, a prepolymer, etc., but not limited thereto. A homopolymer refers to the polymer formed by the polymerization of one monomer. A copolymer refers to the polymer formed by the polymerization of two or more different monomers. For example, copolymers may comprise: random copolymers, such as a structure of -AABABBBAAABBA-; alternating copolymers, such as a structure of -ABABABAB-; graft copolymers, such as a structure of -AA(A-BBBB)AA(A-BBBB)AAA-; and block copolymers, such as a structure of -AAAAA-BBBBBB-AAAAA-. The term “polymer” includes but is not limited to an oligomer. An oligomer refers to a polymer with 2-20, typically 2-5, repeating units.

Unless otherwise specified, the term “resin” of the present disclosure is a widely used common name of a synthetic polymer and is construed as comprising monomer and its combination, polymer and its combination or a combination of monomer and its polymer, but not limited thereto.

Unless otherwise specified, according to the present disclosure, a modification comprises a product derived from a resin with its reactive functional group modified, a product derived from a prepolymerization reaction of a resin and other resins, a product derived from a crosslinking reaction of a resin and other resins, a product derived from homopolymerizing a resin, a product derived from copolymerizing a resin and other resins, etc.

As used herein, “vinyl group-containing” refers to the presence of an ethylenic carbon-carbon double bond (C═C) or a functional group derived therefrom in a compound. Therefore, examples of “vinyl” or “vinyl group-containing” may include, but not limited to, a structure containing a vinyl group, a styryl group, an allyl group, a vinylbenzyl group, a methacrylate group or the like. Unless otherwise specified, the position of the aforesaid functional group is not particularly limited and may be located at the terminal of a long-chain structure. Therefore, for example, a vinyl group-containing resin represents a resin containing a vinyl group, a styryl group, an allyl group, a vinylbenzyl group, a methacrylate group or the like, but not limited thereto.

As used herein, part(s) by weight represents weight part(s) in any weight unit, such as but not limited to gram, kilogram, pound and so on. For example, 100 parts by weight of a vinyl group-containing resin may represent 100 grams of the vinyl group-containing resin, 100 kilograms of the vinyl group-containing resin or 100 pounds of the vinyl group-containing resin, but not limited thereto. As used herein, if the amount of components is presented in a proportional relationship, the actual amount can be any amount that conforms to the proportional relationship.

The following embodiments and examples are illustrative in nature and are not intended to limit the present disclosure and its application. In addition, the present disclosure is not bound by any theory described in the background and summary above or the following embodiments or examples.

As described above, a main object of the present disclosure is to provide a resin composition, comprising a vinyl group-containing resin and a phosphorus-containing copolymer, wherein the phosphorus-containing copolymer is prepared from a mixture subjected to a copolymerization reaction, and the mixture comprises a vinyl group-containing benzocyclobutene of Formula (1) and a phosphorus-containing compound of Formula (2):

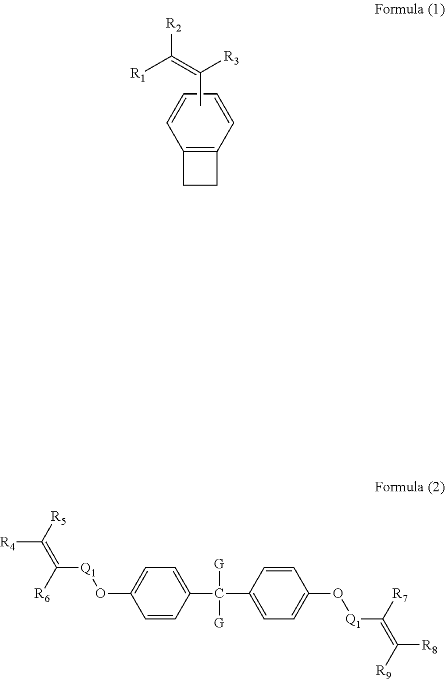

wherein R₁ to R₉ are each independently hydrogen or a C₁ to C₃ alkyl group (such as but not limited to methyl, ethyl, n-propyl or isopropyl), Q₁ are each independently a —(C—O)— group (i.e., carbonyl group) or a *—CH₂—C₆H₄— group, wherein * indicates bonding to oxygen atom, and each G is independently a monovalent phosphorus-containing group represented by Formula (3) or Formula (4);

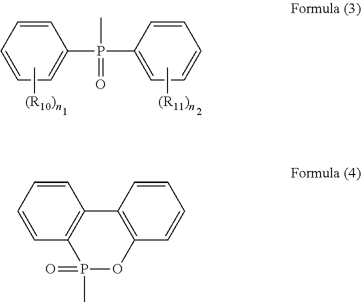

wherein n₁ and n₂ are each independently an integer of 0 to 3, and R₁₀ and R₁₁ are each independently a C1 to C3 alkyl group (such as but not limited to methyl, ethyl, n-propyl or isopropyl).

For example, in one embodiment, amounts of the vinyl group-containing resin and the phosphorus-containing copolymer are not particularly limited. For example, the resin composition of the present disclosure may comprise 100 parts by weight of the vinyl group-containing resin and 25 parts by weight to 50 parts by weight of the phosphorus-containing copolymer. For example, relative to 100 parts by weight of the vinyl group-containing resin, the resin composition of the present disclosure may contain 25 parts by weight, 30 parts by weight, 35 parts by weight, 40 parts by weight, 45 parts by weight or 50 parts by weight of the phosphorus-containing copolymer, but not limited thereto.

For example, in one embodiment, the conditions of the copolymerization reaction are not particularly limited. For example, the mixture comprising the vinyl group-containing benzocyclobutene of Formula (1) and the phosphorus-containing compound of Formula (2) may be subjected to a copolymerization reaction at high temperature (such as but not limited to 100° C. to 150° C.). For example, in one embodiment, the mixture may further comprise other components. For example, the mixture may comprise a radical initiator, such that the copolymerization reaction is carried out in the presence of the radical initiator; the type of radical initiator is not particularly limited and may comprise dibenzoyl peroxide. In addition, the time of the copolymerization reaction is not particularly limited, such as between 10 hours and 30 hours.

For example, in one embodiment, the molar ratio of the vinyl group-containing benzocyclobutene of Formula (1) and the phosphorus-containing compound of Formula (2) is not particularly limited, such as between 1:7 and 3:7.

For example, in one embodiment, the weight average molecular weight of the phosphorus-containing copolymer may be adjusted by changing the conditions of the copolymerization reaction. For example, in one embodiment, the phosphorus-containing copolymer has a weight average molecular weight of between 3,000 and 5,000.

For example, in one embodiment, the phosphorus-containing compound of Formula (2) comprises a compound of Formula (2-1), a compound of Formula (2-2), a compound of Formula (2-3), a compound of Formula (2-4) or a combination thereof:

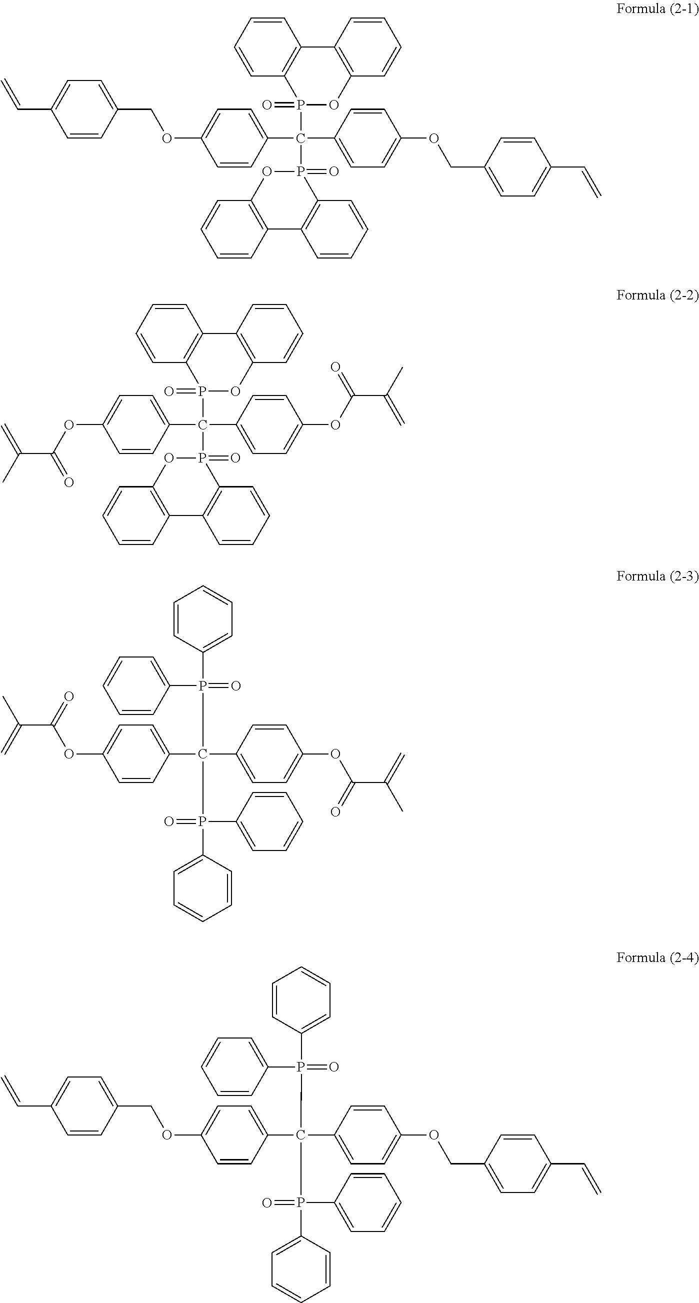

For example, in one embodiment, the vinyl group-containing benzocyclobutene of Formula (1) may comprise, but not limited to, a benzocyclobutene containing a vinyl group, an allyl group, etc.

For example, in one embodiment, the type of the vinyl group-containing resin is not particularly limited and may be any resin containing a vinyl group, a styryl group, an allyl group, a vinylbenzyl group, a methacrylate group or the like, but not limited thereto. For example, in one embodiment, the vinyl group-containing resin comprises a vinyl group-containing polyphenylene ether resin, a maleimide resin, bis(vinylphenyl)ethane, a compound of Formula (5), a styrene-butadiene copolymer, a polybutadiene resin, a diene-containing fluorene compound, a divinylbenzene-terminated hydrogenated polybutadiene resin or a combination thereof,

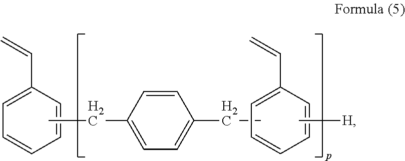

wherein p is 1 to 20.

The vinyl group-containing polyphenylene ether resin may include but is not limited to a polyphenylene ether resin containing a vinyl group, an allyl group, a vinylbenzyl group, or a methacrylate group. For example, in one embodiment, the vinyl group-containing polyphenylene ether resin comprises a vinylbenzyl group-containing biphenyl polyphenylene ether resin, a methacrylate group-containing polyphenylene ether resin (i.e., methacryloyl group-containing polyphenylene ether resin), an allyl group-containing polyphenylene ether resin, a vinylbenzyl group-modified bisphenol A polyphenylene ether resin, a chain-extended vinyl group-containing polyphenylene ether resin or a combination thereof. For example, the vinyl group-containing polyphenylene ether resin may be a vinylbenzyl group-terminated polyphenylene ether resin with a number average molecular weight of about 1200 (such as OPE-2st 1200, available from Mitsubishi Gas Chemical Co., Inc.), a vinylbenzyl group-terminated polyphenylene ether resin with a number average molecular weight of about 2200 (such as OPE-2st 2200, available from Mitsubishi Gas Chemical Co., Inc.), a methacrylate group-containing polyphenylene ether resin with a number average molecular weight of about 1900 to 2300 (such as SA9000, available from Sabic), a vinylbenzyl group-modified bisphenol A polyphenylene ether resin with a number average molecular weight of about 2400 to 2800, a chain-extended vinyl group-containing polyphenylene ether resin with a number average molecular weight of about 2200 to 3000, or a combination thereof. The chain-extended vinyl group-containing polyphenylene ether resin may include various polyphenylene ether resins disclosed in the US Patent Application Publication No. 2016/0185904 A1, all of which are incorporated herein by reference in their entirety.

The maleimide resin may comprise biphenyl aralkyl maleimide resin, 4,4′-diphenylmethane bismaleimide, polyphenylmethane maleimide (a.k.a. oligomer of phenylmethane maleimide), bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenyl methane bismaleimide, m-phenylene bismaleimide, 4-methyl-1,3-phenylene bismaleimide, 1,6-bismaleimide-(2,2,4-trimethyl) hexane, N-2,3-xylylmaleimide, N-2,6-xylylmaleimide, N-phenylmaleimide, vinyl benzyl maleimide (VBM), maleimide containing a biphenyl structure, maleimide resin containing aliphatic long chain structure, prepolymer of diallyl compound and maleimide resin, prepolymer of multi-functional amine (i.e., an amine including two or more amino groups) and maleimide resin, prepolymer of acid phenol compound and maleimide resin, or a combination thereof. These components should be construed as including their modifications.

For example, examples of the maleimide resin include but are not limited to products such as BMI-1000, BMI-1000H, BMI-1100, BMI-1100H, BMI-2000, BMI-2300, BMI-3000, BMI-3000H, BMI-4000, BMI-5000, BMI-5100, BMI-TMH, BMI-7000, and BMI-7000H available from Daiwakasei Industry, products such as BMI-70 and BMI-80 available from K.I Chemical Industry Co., Ltd., or products such as MIR-3000 and MIR-5000 available from Nippon Kayaku. For example, examples of the maleimide resin containing aliphatic long chain structure (such as containing C₅ to C₅₀ aliphatic long chain structure) include, but are not limited to, products such as BMI-689, BMI-1400, BMI-1500, BMI-1700, BMI-2500, BMI-3000, BMI-5000 and BMI-6000 available from Designer Molecules Inc.

For example, in one embodiment, the bis(vinylphenyl)ethane includes but is not limited to 1,2-bis(4-vinylphenyl)ethane, 1,2-(3-vinylphenyl-4-vinylphenyl)ethane, 1,2-bis(3-vinylphenyl)ethane or a combination thereof.

For example, in one embodiment, the styrene-butadiene copolymer disclosed herein comprises but is not limited to a styrene-butadiene random copolymer, a styrene-butadiene alternating copolymer, a styrene-butadiene graft copolymer, a styrene-butadiene block copolymer or a combination thereof.

In one embodiment, for example, the resin composition of the present disclosure may further optionally comprise inorganic filler, curing accelerator, flame retardant, polymerization inhibitor, solvent, silane coupling agent, coloring agent, toughening agent or a combination thereof. Unless otherwise specified, relative to 100 parts by weight of the vinyl group-containing resin, the content of any aforesaid component may be 0.001 to 300 parts by weight, such as 0.001, 0.01, 0.1, 1, 5, 10, 20, 30, 40, 50, 60, 70, 80, 90, 100, 150, 200, 250 or 300 parts by weight, such as 30 to 150 parts by weight or 200 to 300 parts by weight.

The inorganic filler may be any one or more inorganic fillers used for preparing a resin film, a prepreg, a laminate or a printed circuit board; examples of inorganic filler include but are not limited to silica (fused, non-fused, porous or hollow type), aluminum oxide, aluminum hydroxide, magnesium oxide, magnesium hydroxide, calcium carbonate, aluminum nitride, boron nitride, aluminum silicon carbide, silicon carbide, titanium dioxide, zinc oxide, zirconium oxide, mica, boehmite (AlOOH), calcined talc, talc, silicon nitride, calcined kaolin, hollow porous particle or a combination thereof. Moreover, the inorganic filler can be spherical, fibrous, plate-like, particulate, flake-like, whisker-like or a combination thereof in shape and can be optionally pretreated by a silane coupling agent. In some embodiments, the present disclosure uses the silica (SC2050) available from Admatechs. For example, relative to 100 parts by weight of the vinyl group-containing resin, the amount of inorganic filler used in the present disclosure is not particularly limited, and may range from 30 parts by weight to 200 parts by weight, preferably 60 parts by weight to 120 parts by weight.

The curing accelerator (including curing initiator) may comprise a catalyst, such as a Lewis base or a Lewis acid. The Lewis base may comprise any one or more of imidazole, boron trifluoride-amine complex, ethyltriphenyl phosphonium chloride, 2-methylimidazole (2 MI), 2-phenyl-1H-imidazole (2PZ), 2-ethyl-4-methylimidazole (2E4 MI), triphenylphosphine (TPP) and 4-dimethylaminopyridine (DMAP). The Lewis acid may comprise metal salt compounds, such as those of manganese, iron, cobalt, nickel, copper and zinc, such as zinc octanoate or cobalt octanoate.

The curing accelerator may also encompass curing initiator such as a peroxide capable of producing free radicals, and examples of the curing initiator may comprise but not limited to: benzoyl peroxide, dicumyl peroxide, 2,5-dimethyl-2,5-di(t-butylperoxy) hexane, 2,5-dimethyl-2,5-di(t-butylperoxy)-3-hexyne, di-t-butyl peroxide, di(t-butylperoxyisopropyl)benzene, di(t-butylperoxy) phthalate, di(t-butylperoxy) isophthalate, t-butyl peroxybenzoate, 2,2-di(t-butylperoxy) butane, 2,2-di(t-butylperoxy) octane, 2,5-dimethyl-2,5-di(benzoyl peroxy) hexane, lauroyl peroxide, t-hexyl peroxypivalate, dibutylperoxyisopropylbenzene, bis(4-t-butylcyclohexyl) peroxydicarbonate or a combination thereof. For example, relative to 100 parts by weight of the vinyl group-containing resin, the amount of curing accelerator used in the present disclosure may range from 0.01 to 5 parts by weight, preferably 0.1 to 0.5 part by weight, more preferably 0.1 to 0.25 part by weight.

For example, the flame retardant used herein may be any one or more flame retardants useful for preparing a prepreg, a resin film, a laminate or a printed circuit board, examples including but not limited to a phosphorus-containing flame retardant, preferably comprising ammonium polyphosphate, hydroquinone bis-(diphenyl phosphate), bisphenol A bis-(diphenylphosphate), tri (2-carboxyethyl) phosphine (TCEP), phosphoric acid tris(chloroisopropyl) ester, trimethyl phosphate (TMP), dimethyl methyl phosphonate (DMMP), resorcinol bis(dixylenyl phosphate) (RDXP, such as commercially available PX-200, PX-201, and PX-202), phosphazene (such as commercially available SPB-100, SPH-100, and SPV-100), melamine polyphosphate, DOPO (9,10-dihydro-9-oxa-10-phosphaphenanthrene-10-oxide) and its derivatives or resins, DPPO (diphenylphosphine oxide) and its derivatives or resins, melamine cyanurate, tri-hydroxy ethyl isocyanurate, aluminium phosphinate (e.g., commercially available OP-930 and OP-935), and a combination thereof.

For example, the flame retardant may be a DPPO compound (e.g., di-DPPO compound, such as commercially available PQ-60), a DOPO compound (e.g., di-DOPO compound), a DOPO resin (e.g., DOPO-HQ, DOPO-NQ, DOPO-PN, and DOPO-BPN) and a DOPO-containing epoxy resin, wherein DOPO-PN is a DOPO phenol novolac compound, and DOPO-BPN may be a DOPO-containing bisphenol novolac compound, such as DOPO-BPAN (DOPO-bisphenol A novolac), DOPO-BPFN (DOPO-bisphenol F novolac) or DOPO-BPSN (DOPO-bisphenol S novolac).

In one embodiment, for example, the polymerization inhibitor used herein is not particularly limited and may be any polymerization inhibitor known in the field to which this disclosure pertains, including but not limited to various commercially available polymerization inhibitor products. For example, the polymerization inhibitor may comprise, but not limited to, 1,1-diphenyl-2-picrylhydrazyl radical, methyl acrylonitrile, dithioester, nitroxide-mediated radical, triphenylmethyl radical, metal ion radical, sulfur radical, hydroquinone, 4-methoxyphenol, p-benzoquinone, phenothiazine, β-phenylnaphthylamine, 4-t-butylcatechol, methylene blue, 2,2′-methylenebis(4-ethyl-6-t-butyl 4,4′-butylidenebis(6-t-butyl-3-methylphenol), phenol) or a combination thereof. For example, the nitroxide-mediated radical may comprise, but not limited to, nitroxide radicals derived from cyclic hydroxylamines, such as 2,2,6,6-substituted piperidine 1-oxyl free radical, 2,2,5,5-substituted pyrrolidine 1-oxyl free radical or the like. Preferred substitutes include alkyl groups with 4 or fewer carbon atoms, such as methyl group or ethyl group. Examples of the compound containing a nitroxide radical include such as 2,2,6,6-tetramethylpiperidine 1-oxyl free radical, 2,2,6,6-tetraethylpiperidine 1-oxyl free radical, 2,2,6,6-tetramethyl-4-oxo-piperidine 1-oxyl free radical, 2,2,5,5-tetramethylpyrrolidine 1-oxyl free radical, 1,1,3,3-tetramethyl-2-isoindoline oxygen radical, N,N-di-tert-butylamine oxygen free radical and so on. Nitroxide radicals may also be replaced by using stable radicals such as galvinoxyl radicals. The polymerization inhibitor suitable for the resin composition of the present disclosure may include products derived from the polymerization inhibitor with its hydrogen atom or group substituted by other atom or group. Examples include products derived from a polymerization inhibitor with its hydrogen atom substituted by an amino group, a hydroxyl group, a carbonyl group or the like.

The purpose of adding solvent is to change the solid content of the resin composition and to adjust the viscosity of the resin composition. For example, the solvent may comprise, but not limited to, methanol, ethanol, ethylene glycol monomethyl ether, acetone, butanone (methyl ethyl ketone), methyl isobutyl ketone, cyclohexanone, toluene, xylene, methoxyethyl acetate, ethoxyethyl acetate, propoxyethyl acetate, ethyl acetate, dimethylformamide, dimethylacetamide, propylene glycol methyl ether, or a mixture thereof. The amount of solvent is not particularly limited and may be adjusted according to the viscosity required for the resin composition.

The silane coupling agent may include various silanes (such as but not limited to siloxane) or a combination thereof and may be further categorized according to the functional groups into amino silane, epoxide silane, vinyl silane, acrylate silane, methacrylate silane, hydroxyl silane, isocyanate silane, methacryloxy silane and acryloxy silane.

The coloring agent suitable for the present disclosure may comprise, but not limited to, dye or pigment.

The purpose of adding toughening agent is to improve the toughness of the resin composition. The toughening agent may comprise, but not limited to, rubber resin, carboxyl-terminated butadiene acrylonitrile rubber (CTBN rubber), core-shell rubber, or a combination thereof.

In addition to the aforesaid resin composition, the present disclosure also provides an article made from the resin composition, such as those suitable for use as components in various electronic products, including but not limited to a prepreg, a resin film, a laminate or a printed circuit board.

For example, the resin composition of the present disclosure can be used to make a prepreg, which comprises a reinforcement material and a layered structure disposed thereon. The layered structure is formed by heating the resin composition at a high temperature to the semi-cured state (B-stage). Suitable baking temperature for making a prepreg may be for example 80° C. to 160° C., preferably 100° C. to 140° C. For example, the reinforcement material may be any one of a fiber material, woven fabric, and non-woven fabric, and the woven fabric preferably comprises fiberglass fabrics. The type of the fiberglass fabric is not particularly limited and may be any fiberglass fabrics used for a printed circuit board, such as E-glass fabric, D-glass fabric, S-glass fabric, T-glass fabric, L-glass fabric, Q-glass fabric or QL-glass fabric (glass fabric with hybrid structure made of Q-glass and L-glass). The fiber may comprise yarns and rovings, in spread form or standard form, and the shape of terminal face may be round or flat. Non-woven fabric preferably comprises liquid crystal polymer non-woven fabric, such as polyester non-woven fabric, polyurethane non-woven fabric and so on, but not limited thereto. Woven fabric may also comprise liquid crystal polymer woven fabric, such as polyester woven fabric, polyurethane woven fabric and so on, but not limited thereto. The reinforcement material may increase the mechanical strength of the prepreg. In one preferred embodiment, the reinforcement material can also be optionally pre-treated by a silane coupling agent. The prepreg may be further heated and cured to the cured state (C-stage) to form an insulation layer.

For example, the resin composition of the disclosure can be used to make a resin film, which is prepared by heating and baking to semi-cure the resin composition. The resin composition may be selectively coated on a supporting material, which includes but is not limited to a liquid crystal polymer film, a polytetrafluoroethylene film, a polyethylene terephthalate film (PET film), a polyimide film (PI film), a metal foil or a resin-coated copper (RCC), followed by heating and baking to semi-cure the resin composition to form the resin film.

For example, the resin composition of the present disclosure may be made into a laminate, which comprises at least two metal foils and at least one insulation layer disposed between the metal foils, wherein the insulation layer is made by curing the resin composition at high temperature and high pressure to the C-stage, a suitable curing temperature being for example between 180° C. and 240° C. and preferably between 200° C. and 220° C., a suitable curing time being 90 to 150 minutes and preferably 90 to 120 minutes, and a suitable lamination pressure being for example between 250 psi and 600 psi and preferably between 400 psi and 500 psi. The insulation layer may be obtained by curing the aforesaid prepreg or resin film. The metal foil may contain copper, aluminum, nickel, platinum, silver, gold or alloy thereof, such as a copper foil. In a preferred embodiment, the laminate is a copper-clad laminate.

In one embodiment, the laminate may be further processed by trace formation processes to obtain a circuit board, such as a printed circuit board.

For example, in one embodiment, an article made from the resin composition from each embodiment contains a reinforcement material or a supporting material and a semi-cured or cured product obtained by heating and chemically crosslinking the resin composition.

In one or more embodiments, the articles made from the resin composition disclosed herein may have at least one, preferably at least two, more or all, of the following properties:
a dissipation factor as measured by reference to JIS C2565 at 10 GHz of less than or equal to 0.0027, such as between 0.0021 and 0.0027;
a copper foil peeling strength as measured by reference to IPC-TM-650 2.4.8 of greater than or equal to 4.12 lb/in, such as between 4.12 lb/in and 5.04 lb/in;
a flame retardancy of V-O rating as measured by reference to UL94 standard; and
an X-axis coefficient of thermal expansion as measured by reference to IPC-TM-650 2.4.24.5 of less than or equal to 11.7 ppm/° C., such as between 11.1 ppm/° C. and 11.7 ppm/° C.

Methods for measuring the aforesaid properties will be elaborated in detail below.

Raw materials below were used to prepare the resin compositions of various Examples and Comparative Examples of the present disclosure according to the amount listed in Table 1 to Table 3 and further fabricated to prepare test samples.

Materials and reagents used in Synthesis Examples, Examples and Comparative Examples disclosed herein are listed below:
Phosphorus-containing copolymer of the present disclosure: CP1 to CP3, as described in Synthesis Example 1 to Synthesis Example 3.
Other polymer: CP4 to CP5, as described in Synthesis Example 4 to Synthesis Example 5.
OPE-2st 2200: vinylbenzyl-terminated polyphenylene ether resin, available from Mitsubishi Gas Chemical Co., Inc.
SA9000: methacrylate group-containing polyphenylene ether resin, available from Sabic.
MIR-5000: biphenyl aralkyl maleimide resin, available from Nippon Kayaku.
BVPE: 1,2-bis(4-vinylphenyl)ethane, commercially available.
Compound of Formula (5): as described in Synthesis Example 6.
Ricon 100: styrene-butadiene copolymer, available from Cray Valley.
B-1000: polybutadiene resin, available from Nippon Soda Co., Ltd.
CHR-2st: diene-containing fluorene compound, available from Shandong Xingshun New Material Co., Ltd.
MD3501: divinylbenzene-terminated hydrogenated polybutadiene resin, available from Kraton Corporation.
4-vinylbenzocyclobutene: available from Kingyorker Enterprise Co., Ltd.
Compounds of Formula (2-1) to Formula (2-3): phosphorus-containing compound, as shown below, available from CHENG CI CORPORATION.

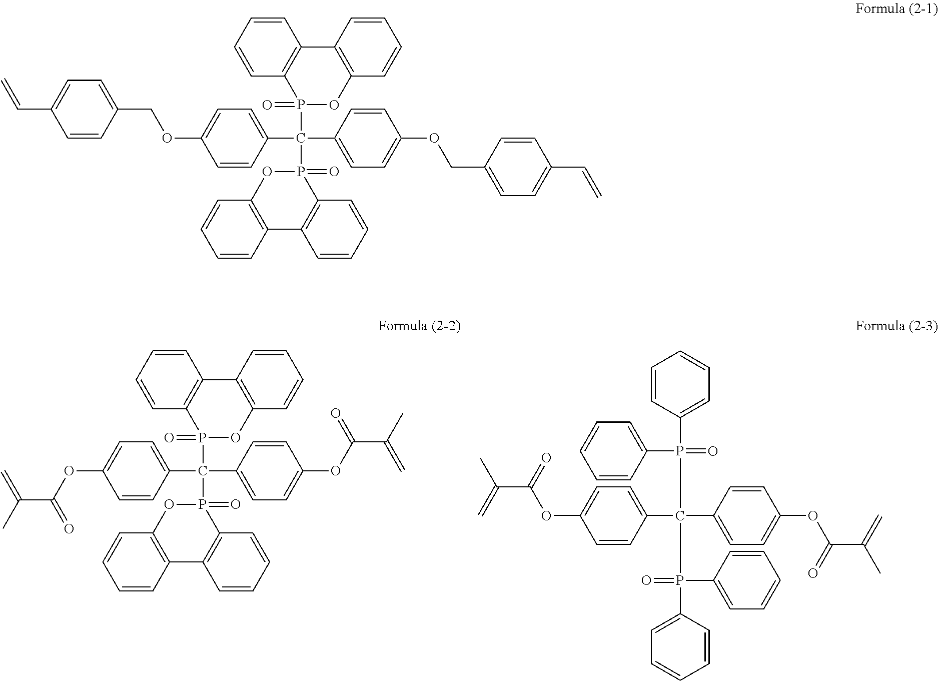

SC2050: silica, available from Admatechs.
25B: 2,5-dimethyl-2,5-di(t-butylperoxy)-3-hexyne, commercially available. MEK: methyl ethyl ketone, commercially available.

### Synthesis Example 1

0.7 mole of a phosphorus-containing compound of Formula (2-1) as the first monomer and solvent mixture containing dimethylacetamide and MEK (at a weight ratio of 1:2) are added to a reactor, stirred and dissolved at 120° C., followed by adding 0.3 mole of 4-vinylbenzocyclobutene as the second monomer and 0.5 wt % of benzoyl peroxide (BPO) based on the total weight of the aforesaid raw materials excluding solvent, and reacted at 120° C. for 20 hours, so as to obtain a phosphorus-containing copolymer CP1 of the present disclosure with a solid content of 50% to 60%. A GPC analysis showed that the weight average molecular weight of CP1 is about 4,200.

### Synthesis Example 2

Substantially the same as Synthesis Example 1, except that a phosphorus-containing compound of Formula (2-2) was used as the first monomer to obtain a phosphorus-containing copolymer CP2 of the present disclosure. A GPC analysis showed that the weight average molecular weight of CP2 is about 4,000.

### Synthesis Example 3

Substantially the same as Synthesis Example 1, except that a phosphorus-containing compound of Formula (2-3) was used as the first monomer to obtain a phosphorus-containing copolymer CP3 of the present disclosure. A GPC analysis showed that the weight average molecular weight of CP3 is about 3,800.

### Synthesis Example 4

0.5 mole of 4-vinylbenzocyclobutene, 0.01 mole of 2,2,6,6-tetramethyl piperidinooxy (TEMPO, commercially available) and a proper amount of methanol were added to a reactor, frozen for 2 minutes in a liquid nitrogen atmosphere, evacuated for 5 minutes followed by argon introduction, and the aforesaid freezing, evacuation and argon introduction processes were repeated for three times; after that, the system was degassed and then reacted at 130° C. for 24 hours to obtain a crude polymerization product, which was stirred and added dropwise with methanol, followed by 0.5 hour of stirring. A polymer CP4 was obtained after filtration and drying. A GPC analysis showed that the weight average molecular weight of CP4 is about 4,000.

### Synthesis Example 5

Substantially the same as Synthesis Example 1, except that a phosphazene compound (SPV-100, available from Otsuka Chemical Co., Ltd.) was used as the first monomer to obtain a polymer CP5. A GPC analysis showed that the weight average molecular weight of CP5 is about 3,200.

### Synthesis Example 6

296 parts by weight of 2-bromoethylbenzene (manufactured by Tokyo Chemical Industry Co., Ltd.), 70 parts by weight of α,α′-dichloro-p-xylene (manufactured by Tokyo Chemical Industry Co., Ltd.) and 18.4 parts by weight of methanesulfonic acid (manufactured by Tokyo Chemical Industry Co., Ltd.) were reacted at 130° C. for 8 hours, followed by being cooled to room temperature, neutralized with aqueous sodium hydroxide solution, and extracted with 1,200 parts by weight of toluene. The organic layer was washed with water. The solvent and excess 2-bromoethylbenzene were removed by distillation under heating and reduced pressure to obtain the intermediate. The molar ratio of 2-bromoethylbenzene to α,α′-dichloro-p-xylene may be 4:1; methanesulfonic acid was used as an acidic catalyst and may be replaced by other acidic catalysts such as hydrochloric acid and phosphoric acid; and the reaction conditions may be 40° C. to 180° C. for 0.5 to 20 hours.

22 parts by weight of the aforesaid intermediate, 50 parts by weight of toluene (other aromatic solvents may also be used, such as xylene), 150 parts by weight of dimethyl sulfoxide (other aprotic polar solvents may also be used, such as dimethyl sulfone), 15 parts by weight of water and 5.4 parts by weight of sodium hydroxide (other alkaline catalysts may also be used, such as potassium hydroxide and potassium carbonate) were reacted at 40° C. for 5 hours, followed by being cooled to room temperature, and then added with 100 parts by weight of toluene. The organic layer was washed with water, and the solvent was removed by distillation under heating and reduced pressure to obtain the compound of Formula (5).

Compositions (in part by weight) and test results of resin compositions of Examples and Comparative Examples are listed below, wherein the part by weight refers to the amount, in part by weight, of each component with a solid content of 100%. For example, Example E1 contains 35 parts by weight of a phosphorus-containing copolymer CP1, indicating the amount of phosphorus-containing copolymer CP1, with a solid content of 100%, is 35 parts by weight.

Compositions and test results of resin compositions of Examples and Comparative Examples are listed below (in part by weight).

TABLE 1
Resin compositions of Examples (in part by weight) and test results

| Component | Name | E1 | E2 | E3 | E4 | E5 |
|---|---|---|---|---|---|---|
| phosphorus-containing copolymer | CP1 | 35 | 35 | 35 | | |
| | CP2 | | | | 35 | |
| | CP3 | | | | | 35 |
| other polymer | CP4 | | | | | |
| | CP5 | | | | | |
| vinyl group-containing resin | OPE-2st 2200 | | 10 | | 5 | 5 |
| | SA9000 | 100 | 10 | 50 | 50 | 5 |
| | MIR-5000 | | 10 | | 10 | |
| | BVPE | | | 10 | 10 | |
| | Formula (5) | | | 20 | | 40 |
| | Ricon100 | | | 5 | | 30 |
| | B-1000 | | 5 | | | 20 |
| | CHR-2st | | | 15 | 15 | |
| | MD3501 | | 65 | | 10 | |
| monomer | 4-vinylbenzocyclobutene | | | | | |
| | Formula (2-1) | | | | | |
| inorganic filler | SC2050 | 80 | 80 | 80 | 80 | 80 |
| curing accelerator | 25B | 0.15 | 0.15 | 0.15 | 0.15 | 0.15 |
| solvent | MEK | 100 | 100 | 100 | 100 | 100 |
| property | unit | E1 | E2 | E3 | E4 | E5 |
| dissipation factor | none | 0.0023 | 0.0025 | 0.0025 | 0.0024 | 0.0027 |
| copper foil peeling strength | lb/in | 4.12 | 4.16 | 4.31 | 4.48 | 4.78 |
| flame retardancy | none | V-0 | V-0 | V-0 | V-0 | V-0 |
| X-axis coefficient of thermal expansion | ppm/° C. | 11.3 | 11.1 | 11.7 | 11.5 | 11.3 |

TABLE 2
Resin compositions of Examples (in part by weight) and test results

| Component | Name | E6 | E7 | E8 | E9 |
|---|---|---|---|---|---|
| phosphorus-containing copolymer | CP1 | 25 | 50 | 10 | 5 |
| | CP2 | | | 10 | 10 |
| | CP3 | | | 15 | 15 |
| other polymer | CP4 | | | | |
| | CP5 | | | | |
| vinyl group-containing resin | OPE-2st 2200 | | | 27 | 34 |
| | SA9000 | 100 | 100 | 40 | 10 |
| | MIR-5000 | | | 2 | 4 |
| | BVPE | | | 5 | 3 |
| | Formula (5) | | | 5 | 13 |
| | Ricon100 | | | 6 | 6 |
| | B-1000 | | | 5 | 14 |
| | CHR-2st | | | 5 | 10 |
| | MD3501 | | | 5 | 6 |
| monomer | 4-vinylbenzocyclobutene | | | | |
| | Formula (2-1) | | | | |
| inorganic filler | SC2050 | 80 | 80 | 60 | 120 |
| curing accelerator | 25B | 0.15 | 0.15 | 0.10 | 0.25 |
| solvent | MEK | 100 | 100 | 80 | 120 |
| property | unit | E6 | E7 | E8 | E9 |
| dissipation factor | none | 0.0024 | 0.0025 | 0.0023 | 0.0021 |
| copper foil peeling strength | lb/in | 4.34 | 4.46 | 5.04 | 5.02 |
| flame retardancy | none | V-0 | V-0 | V-0 | V-0 |
| X-axis coefficient of thermal expansion | ppm/° C. | 11.6 | 11.1 | 11.2 | 11.1 |

TABLE 3
Resin compositions of Comparative Examples
(in part by weight) and test results

| Component | Name | C1 | C2 | C3 |
|---|---|---|---|---|
| phosphorus- | CP1 | | | |
| containing | CP2 | | | |
| copolymer | CP3 | | | |
| other polymer | CP4 | 35 | | |
| | CP5 | | 35 | |
| vinyl group- | OPE-2st 2200 | | | |
| containing resin | SA9000 | 100 | 100 | 100 |
| | MIR-5000 | | | |
| | BVPE | | | |
| | Formula (5) | | | |
| | Ricon100 | | | |
| | B-1000 | | | |
| | CHR-2st | | | |
| | MD3501 | | | |
| monomer | 4-vinylbenzo- | | | 2.1 |
| | cyclobutene | | | |
| | Formula (2-1) | | | 32.9 |
| inorganic filler | SC2050 | 80 | 80 | 80 |
| curing accelerator | 25B | 0.15 | 0.15 | 0.15 |
| solvent | MEK | 100 | 100 | 100 |
| property | unit | C1 | C2 | C3 |
| dissipation factor | none | 0.0024 | 0.0035 | 0.0031 |
| copper foil peeling | lb/in | 4.12 | 3.69 | 3.70 |
| strength | | | | |
| flame retardancy | none | burnout | V-1 | burnout |
| X-axis coefficient of | ppm/° C. | 13.1 | 13.2 | 13.5 |
| thermal expansion | | | | |

Samples (specimens) for the properties measured above were prepared as described below and tested and analyzed under specified conditions below.
1. Prepreg 1 (PP 1)
   Resin composition (in part by weight) from each Example or each Comparative Example was separately added to a stirred tank and well-mixed to form a varnish. The varnish was loaded to an impregnation tank, and a fiberglass fabric (e.g., 1078 L-glass fiber fabric, available from Asahi) was impregnated into the impregnation tank to adhere the resin composition onto the fiberglass fabric, followed by heating at 100° C. to 140° C. to the semi-cured state (B-stage) to obtain the prepreg 1, having a resin content of about 70%.
2. Prepreg 2 (PP 2)
   Resin composition (in part by weight) from each Example or each Comparative Example was separately added to a stirred tank and well-mixed to form a varnish. The varnish was loaded to an impregnation tank, and a fiberglass fabric (e.g., 2116 L-glass fiber fabric, available from Asahi) was impregnated into the impregnation tank to adhere the resin composition onto the fiberglass fabric, followed by heating at 100° C. to 140° C. to the semi-cured state (B-stage) to obtain the prepreg 2, having a resin content of about 70%.
3. Copper-containing laminate 1 (obtained by laminating two prepregs 1)
   Two loz hyper very low profile (HVLP) copper foils and two prepregs 1 obtained from 1078 L-glass fiber fabrics impregnated with each Example or Comparative Example were prepared, each prepreg 1 having a resin content of about 70%. A copper foil, two prepregs and a copper foil were superimposed in such order and then subjected to a vacuum condition for lamination at 250 psi to 600 psi and 200° C. to 220° C. for 90 minutes to 120 minutes to form each copper-containing laminate 1. The two prepregs were cured to form an insulation layer between the two copper foils, and the insulation layer has a resin content of about 70%.
4. Copper-free laminate 1 (obtained by laminating two prepregs 1)
   Each copper-containing laminate 1 made by laminating two prepregs 1 obtained above was etched to remove the copper foils on both sides so as to obtain the copper-free laminate 1 (obtained by laminating two prepregs 1).
5. Copper-containing laminate 2 (obtained by laminating two prepregs 2)
   The preparation processes were substantially the same as those described in the copper-containing laminate 1, except that prepregs 2 were used.
6. Copper-free laminate 2 (obtained by laminating two prepregs 2)
   Each copper-containing laminate 2 made by laminating two prepregs 2 obtained above was etched to remove the copper foils on both sides so as to obtain the copper-free laminate 2 (obtained by laminating two prepregs 2).
7. Copper-containing laminate 3 (obtained by laminating six prepregs 1)
   The preparation processes were substantially the same as those described in the copper-containing laminate 1, except that the insulation layer was made from six prepregs 1.
8. Copper-containing laminate 4 (obtained by laminating eight prepregs 1)
   The preparation processes were substantially the same as those described in the copper-containing laminate 1, except that the insulation layer was made from eight prepregs 1.
9. Copper-free laminate 3 (obtained by laminating eight prepregs 1)
   Each copper-containing laminate 4 made by laminating eight prepregs 1 obtained above was etched to remove the copper foils on both sides so as to obtain the copper-free laminate 3 (obtained by laminating eight prepregs 1).

For each sample, test items and test methods are described below.

### Dissipation Factor (Df)

The aforesaid copper-free laminate 1 (obtained by laminating two prepregs 1, having a resin content of about 70%) was subjected to dissipation factor measurement. Each specimen was measured by using a microwave dielectrometer (available from AET Corp.) by reference to JIS C2565 at room temperature (about 25° C.) and under 10 GHz frequency to obtain the dissipation factor. Under a 10 GHz frequency, for a Df value of between 0.0010 and 0.0035, a difference in Df of less than 0.00015 represents no substantial difference (i.e., no significant technical difficulty) in dissipation factor of laminates, and a difference in Df of greater than or equal to 0.00015 represents a substantial difference (i.e., significant technical difficulty) in dissipation factor in different laminates.

### Copper Foil Peeling Strength (1 Ounce, 1 oz Peeling Strength, 1 Oz P/S)

A copper-containing laminate 3 (obtained by laminating six prepregs 1) was cut into a rectangular sample with a width of 24 mm and a length of 80 mm, which was etched to remove surface copper foil to leave a rectangular copper foil with a width of 3.18 mm and a length of greater than 60 mm, and tested by using a tensile strength tester by reference to IPC-TM-650 2.4.8 at room temperature (about 25° C.) to measure the loz (one-ounce) copper foil peeling strength (1 oz P/S), in lb/in. In the technical field to which the present disclosure pertains, higher copper foil peeling strength is better.

Flame Retardancy (a.k.a. Flame Resistance)

A copper-free laminate 3 (obtained by laminating eight prepregs 1) sample was prepared and subjected to the measurement. The flame retardancy test was performed in accordance with the UL94 rating, and the results were represented by V-0, V-1, or V-2, wherein V-O indicates a superior flame retardancy to V-1, V-1 indicates a superior flame retardancy to V-2, and burnout of sample is the worst.

### X-Axis Coefficient of Thermal Expansion (X-CTE)

A copper-free laminate 2 (obtained by laminating two prepregs 2) sample was prepared and subjected to thermal mechanical analysis (TMA). The copper-free laminate 2 was cut into a sample with a length of 24 mm and a width of 3 mm. Each sample was heated from 35° C. to 350° C. at a heating rate of 10° C./minute and then subjected to the measurement of the X-axis coefficient of thermal expansion (ppm/° C.) in a temperature range (designated as a1) of 40° C. to 125° C. by reference to IPC-TM-650 2.4.24.5, wherein the X-axis coefficient of thermal expansion described herein refers to the coefficient of thermal expansion of the sample in X-axis direction. Lower X-axis coefficient of thermal expansion represents a better dimensional change property. A difference in X-axis coefficient of thermal expansion of greater than or equal to 1.2 ppm/° C. represents a substantial difference (i.e., significant technical difficulty) in X-axis coefficient of thermal expansion in different laminates.

The following observations can be made from Table 1 to Table 3.

From Examples E1 to E9, it can be confirmed that the resin composition of the present disclosure and the article made therefrom may achieve improvements in one or more of the following properties including dissipation factor, copper foil peeling strength, flame resistance and X-axis coefficient of thermal expansion.

From the comparison of Examples E1 to E9 and Comparative Examples C1 to C3, it can be found that, if the resin composition does not contain the phosphorus-containing copolymer of the present disclosure, but uses other polymers or contains a first monomer and a second monomer in the resin composition without copolymerizing the two monomers, the corresponding resin composition and the article made therefrom will significantly deteriorate at least one of the following properties including flame resistance and X-axis coefficient of thermal expansion.

In contrast, if the resin composition contains both the phosphorus-containing copolymer of the present disclosure and the vinyl group-containing resin, such as Examples E1 to E9, the corresponding resin composition and the article made therefrom will preferably achieve improvements in all of the following properties including dissipation factor, copper foil peeling strength, flame resistance and X-axis coefficient of thermal expansion.

The above detailed description is merely illustrative in nature and is not intended to limit the embodiments of the subject matter or the applications and uses of such embodiments. As used herein, the term “exemplary” or similar expression means “serving as an example, instance, or illustration.” Any implementation described herein as exemplary is not necessarily to be construed as preferred or advantageous over other implementations, unless otherwise specified.

Moreover, while at least one exemplary example or comparative example has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description will provide those skilled in the art with a convenient guide for implementing the described one or more embodiments and equivalents thereof. Also, the scope defined by the claims includes known equivalents and foreseeable equivalents at the time of filing this patent application.

What is claimed is:

1. A resin composition comprising a vinyl group-containing resin and a phosphorus-containing copolymer, wherein the phosphorus-containing copolymer is prepared from a mixture subjected to a copolymerization reaction, and the mixture comprises a vinyl group-containing benzocyclobutene of Formula (1) and a phosphorus-containing compound of Formula (2): 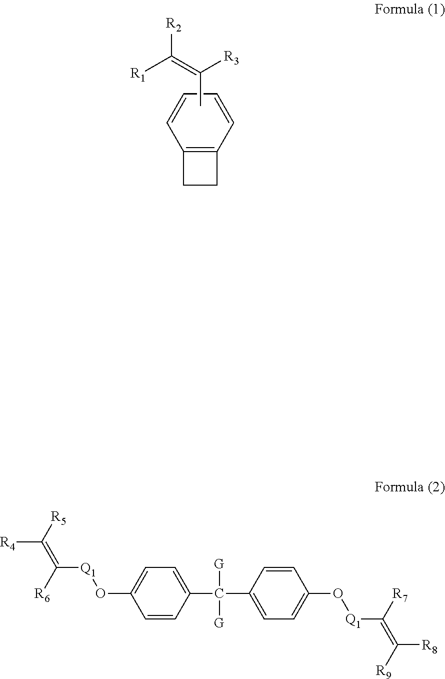
wherein R₁ to R₉ are each independently hydrogen or a C₁ to C₃ alkyl group, Q₁ are each independently a —(C—O)— group or a *—CH₂—C₆H₄— group, wherein * indicates bonding to oxygen atom, and each G is independently a monovalent phosphorus-containing group represented by Formula (3) or Formula (4); 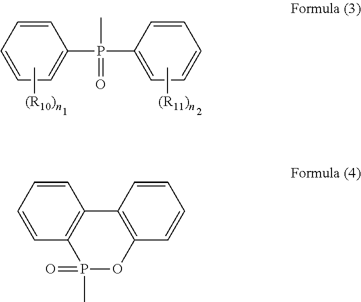
wherein n₁ and n₂ are each independently an integer of 0 to 3, and R₁₀ and Ru are each independently a C₁ to C₃ alkyl group.

2. The resin composition of claim 1, wherein a molar ratio of the vinyl group-containing benzocyclobutene of Formula (1) and the phosphorus-containing compound of Formula (2) in the mixture is between 1:7 and 3:7.

3. The resin composition of claim 1, wherein the phosphorus-containing copolymer has a weight average molecular weight of between 3,000 and 5,000.

4. The resin composition of claim 1, comprising 100 parts by weight of the vinyl group-containing resin and 25 parts by weight to 50 parts by weight of the phosphorus-containing copolymer.

5. The resin composition of claim 1, wherein the vinyl group-containing resin comprises a vinyl group-containing polyphenylene ether resin, a maleimide resin, bis(vinylphenyl)ethane, a compound of Formula (5), a styrene-butadiene copolymer, a polybutadiene resin, a diene-containing fluorene compound, a divinylbenzene-terminated hydrogenated polybutadiene resin or a combination thereof, 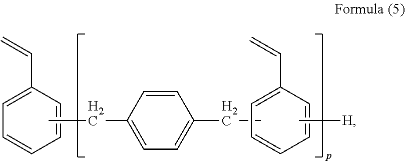
wherein p is 1 to 20.

6. The resin composition of claim 1, further comprising inorganic filler, curing accelerator, flame retardant, polymerization inhibitor, solvent, silane coupling agent, coloring agent, toughening agent or a combination thereof.

7. An article made from the resin composition of claim 1, comprising a prepreg, a resin film, a laminate or a printed circuit board.

8. The article of claim 7, having a dissipation factor as measured by reference to JIS C2565 at 10 GHz of less than or equal to 0.0027.

9. The article of claim 7, having a copper foil peeling strength as measured by reference to IPC-TM-650 2.4.8 of greater than or equal to 4.12 lb/in.

10. The article of claim 7, having a flame retardancy of V-O rating as measured by reference to UL94 standard.

11. The article of claim 7, having an X-axis coefficient of thermal expansion as measured by reference to IPC-TM-650 2.4.24.5 of less than or equal to 11.7 ppm/° C.
